(19) United States
(12) Patent Application Publication
(10) Pub. No.: US 2021/0207472 A1
(43) Pub. Date: Jul. 8, 2021

(54) FLOW METER APPARATUS

(71) Applicant: HALLIBURTON ENERGY SERVICES, INC., Houston, TX (US)

(72) Inventor: Jalpan Piyush DAVE, Singapore (SG)

(73) Assignee: HALLIBURTON ENERGY SERVICES, INC., Houston, TX (US)

(21) Appl. No.: 16/065,019

(22) PCT Filed: Jun. 15, 2017
(86) PCT No.: PCT/US2017/037600

§ 371 Date: Jun. 21, 2018

(51) Int. Cl. E21B 47/10; E21B 47/06

(52) U.S. Cl. CPC E21B 47/10; G01F 1/44; E21B 47/06

(57) ABSTRACT

An apparatus including an elongate tubular body having an inner bore with an inner diameter permitting a fluid flow therethrough. A flapper coupled with the tubular body and a flow meter coupled with the flapper. The flapper is actuatable from a bore open position to a bore restricted position. In the bore open position, the flapper is withdrawn from restricting the inner bore and in the bore restricted position the flow meter is exposed to the fluid flow.

### FIELD

The present disclosure relates generally to volumetric flow measuring apparatus. In particular, the subject matter herein generally relates to volumetric flow measuring apparatus within a tubular body.

### BACKGROUND

Well site operations generally involve a production string having numerous pieces of equipment disposed down hole within a wellbore during production of hydrocarbons from a well. Determining a volumetric flow rate of the well during the production of hydrocarbons can often require shutting down production in order to run one or more flow meters down hole. The process of removing the production string and its related equipment is time consuming and costly, and interrupts the production of hydrocarbons.

### BRIEF DESCRIPTION OF THE DRAWINGS

Implementations of the present technology will now be described, by way of example only, with reference to the attached figures, wherein:

FIG. 1A is a diagrammatic view of a well site with a production string having a flow meter apparatus as disclosed herein;

FIG. 1B is a diagrammatic view of a production string having a flow meter apparatus as disclosed herein;

FIG. 2 is a partial cross section view of an exemplary flow meter apparatus in an open position as disclosed herein;

FIG. 3 is a detailed partial cross section of a portion A-A of the flow meter apparatus of FIG. 2;

FIG. 4 is a partial cross section view of an exemplary flow meter apparatus in an closed position as disclosed herein;

FIG. 5 is a partial cross section view of a second exemplary flow meter apparatus in an closed position as disclosed herein;

FIB 6 is a detailed partial cross section of a portion B-B of the flow meter apparatus of FIG. 5; and

FIG. 7 is a partial cross section view of a third exemplary flow meter apparatus disclosed herein.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like

The present disclosure is directed to an interventionless well flow meter apparatus. The flow meter apparatus can acquire a volumetric flow measurement during hydrocarbon production without requiring removal of a production string.

The following provides a more detailed discussion of the components herein.

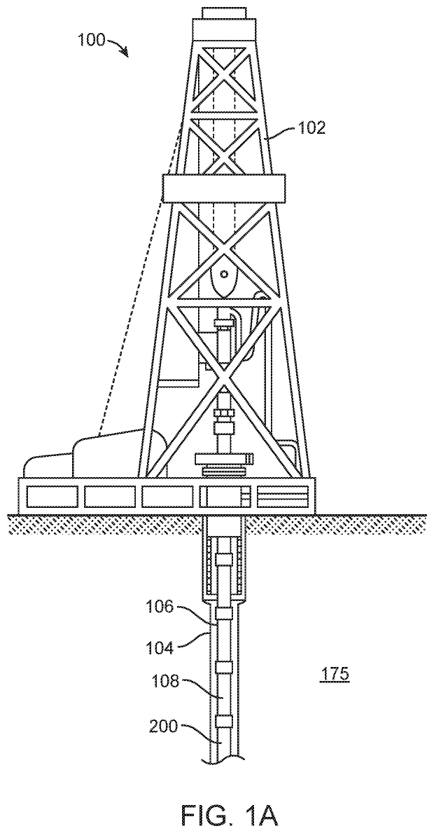

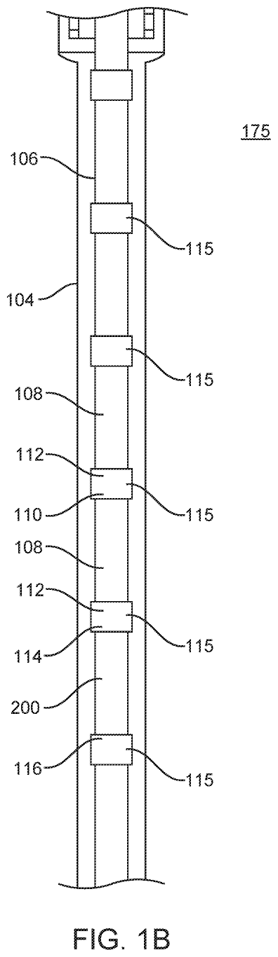

FIG. 1 illustrates an example well site according to the present disclosure. The well site 100 can include one or more rigs 102 disposed above one or more wellbores 104. The wellbore 104 can be a vertical bore, horizontal bore, or a multi-directional bore having a combination of vertical bores and horizontal bores formed in to a subterranean formation 150. The wellbore 104 can be cased and cemented in preparation for hydrocarbon production.

A production string 106 can be received within the cased and cemented wellbore 104 for the extraction of hydrocarbons from the subterranean formation 175. The production string 106 can be formed from a plurality of pieces of production tubing 108 threadably coupled one to the other. The production string 106 can have a flow meter 200 coupled therewith to determine a volumetric flow rate within the production string 106.

FIG. 1B illustrates a production string having a flow meter apparatus 200 coupled therewith. The production string 106 can be a plurality of elongate pieces of production tubing 108 coupled together via collars 115. Each piece of the production tubing 108 can have opposing ends, a proximal end having a first threaded portion 110 and a distal end having a second threaded portion 112. The first threaded portion 110 can be a female threaded portion and the second threaded portion 112 can be a male threaded, thus allowing the first threaded portion 110 of a piece of production tubing 108 to be threadingly coupled with the second threaded portion 112 of an adjacent piece of production tubing 108. The flow meter apparatus 200 can be an elongate body having similarly opposing ends with a first threaded portion 114 and a second threaded portion 116. The first threaded portion 114 can be a female threaded portion and the second threaded portion 116 can be a male threaded, thus allowing the first threaded portion 114 of the flow meter apparatus 200 to be threadingly coupled with the second threaded portion 112 of an adjacent piece of production tubing 108 and the second threaded portion 116 of the flow meter apparatus 200 to be threadingly coupled with the first threaded portion 110 of an adjacent piece of production tubing 108.

It should be noted that while FIGS. 1A and 1B generally depict a land-based operation, those skilled in the art will readily recognize that the principles described herein are equally applicable to subsea operations that employ floating or sea-based platforms and rigs, without departing from the scope of the disclosure.

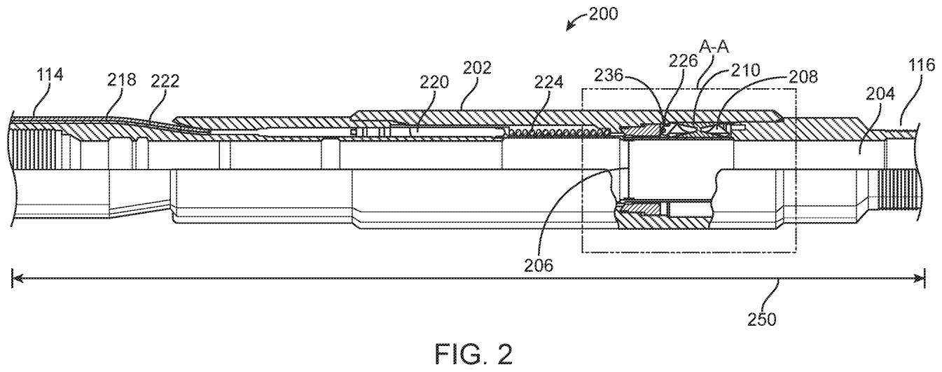

FIG. 2 illustrates an example flow meter apparatus according to the present disclosure. The flow meter apparatus 200 can be coupled with the production string 106 and disposed between adjacent pieces of production tubing 108. The flow meter apparatus 200 can have an elongate tubular body 202 having an inner bore 204 with an inner diameter 206. The inner bore 204 can permit a fluid flow therethrough. In some instances, the fluid flow can be liquid or gaseous hydrocarbons being withdrawn from a subsurface formation.

The inner diameter 206 can remain constant along a length 250 of the elongate tubular body 202 providing a constant fluid flow path and maintaining a consistent volumetric flow rate. The inner diameter 206 may be constant along the entire length of the tubular body 202 or a portion thereof. The inner diameter 206 of the flow meter apparatus can be substantially similar inner diameter so as to provide a constant fluid flow path along the production string 106.

The elongate tubular body can have opposing end portions having a first threaded portion 114 and a second threaded portion 116. The first threaded portion 114 can be a female threaded coupling configured to receive a corresponding male threaded coupling. The second threaded portion 116 can be a male threaded coupling configured to be received by a corresponding female threaded coupling. The first threaded portion 114 and second threaded portion 116 can couple the flow meter apparatus 200 with adjacent portions of a production string 106. In at least one instance, the adjacent portion of the production string 106 can be a subsequent flow meter apparatus 200, such that the production string 106 includes more than one, or a plurality of flow meter apparatuses 200.

The elongate tubular body 202 can have a flapper 208 coupled therewith. The flapper 208 can be actuatable from a bore open position to a bore restricted position. As shown in FIG. 2, in the bore open position the flapper 208 is withdrawn from restricting the inner bore. The flapper 208 can be positioned in the bore open position during normal fluid flow conditions, more specifically during hydrocarbon production through the production string 106. The flapper 208 can be transitioned to the bore restricted position during fluid flow measurements, and then returned to the bore open position.

The flapper 208 can be pivotally, or otherwise rotationally, coupled with the tubular body 202. The flapper 208 can have a pivoting axis above the inner diameter 206, thus preventing the flapper 208 from contracting the inner diameter 206 in the bore open position and impeding the flow through the inner bore 204. The flapper 208 can be freely coupled or otherwise biasedly coupled with the tubular body 202 (such as via a spring). As illustrated, the flapper 208 may be biased by a flapper biasing element 236 configured to transition the flapper 208 upon release of biasing element 218. The flapper biasing element 236 can be a torsion spring coupled with the flapper 208 at the pivotable coupling with the elongate tubular body 202. In at least one instance, the permitted fluid flow through the inner bore 204 can be used to assist movement of the flapper 208.

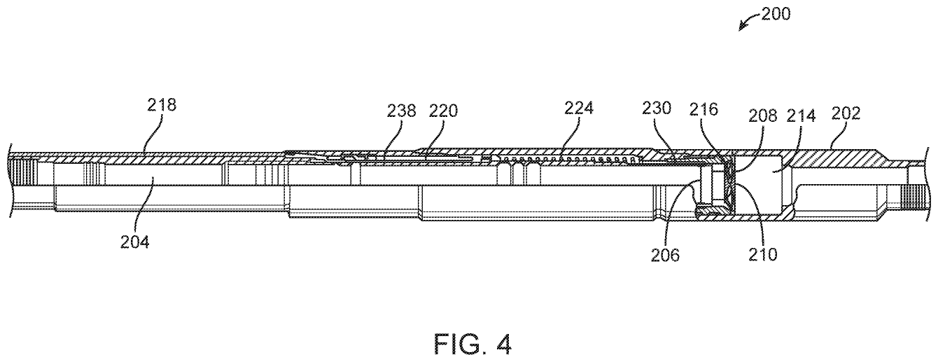

A flow meter 210 can be coupled with the flapper 208 to measure the fluid flow through the inner bore 204. In particular, as discussed further below with respect to FIG. 4, when the flapper 208 is in the bore restricted position the flow meter can be exposed to the fluid flow.

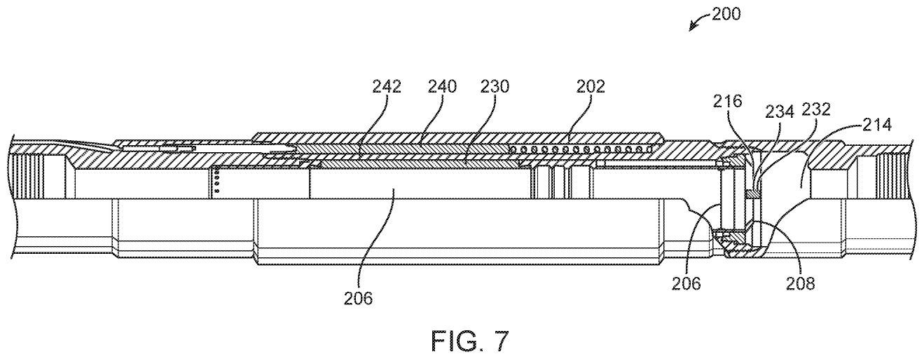

The flow meter 210 can be any apparatus capable of measuring a volumetric flow rate through the inner bore 204 of the elongate tubular body 202 when the flapper 208 is exposed to the permitted fluid flow. The flow meter 210 may be a venturi 212 formed within the flapper 208 as illustrated further below in FIG. 6. Alternatively, as illustrated in FIG. 7, the flow meter 210 can be an orifice plate 232 formed within the flapper 208.

Returning to FIG. 2, the flow meter apparatus 200 can have a control line 218 coupled to an actuator 220. The control line 218 can be configured to receive a signal to operate the actuator 220. The signal can be an electrical impulse, data packet, or other communication received by the actuator 220. The control line 218 can couple the actuator 220 with the surface, thus providing remote operation of the actuator 220. In some instances, the control line 218 can be disposed on an exterior surface 222 of the elongate tubular body 202. The control line can extend along the production string 106 (shown in FIG. 1B) within the wellbore 104 and provide communicative coupling between the actuator 220 and the surface.

In at least one instance, the control line 218 is a tubing encapsulated cable (TEC) acting as a conductor for providing power and signal communication between the flow meter apparatus 200 and a data acquisition system. The control line 218 can be used to transition the flow meter apparatus 200 between the bore open position and the bore restricted position, while also providing communicatively coupling of the flow meter apparatus 200 with a remote data acquisition system collective data from the first pressure sensor 214 and the second pressure sensor 216, which are discussed with respect to FIGS. 4, and 6-7 further below.

The actuator 220 can be operably coupled with the flapper 208 to transition the flapper 208 between the bore restricted position and the bore open position. The actuator 220 can be a hydraulic piston, electric motor, linear actuator, or any other actuator 220 configured to actuate the flapper 208.

A biasing element 224 can be coupled with the flapper 208 and bias the flapper 208 to one of the bore restricted position or the bore open position. In some instances, the flapper 208 can be biased to a bore restricted position to reduce volumetric flow rate absent actuation of the actuator 220. In other instances, the flapper 208 can be biased to a bore open position to maximize volumetric flow rate through the elongate tubular body 202, thus reducing the need to operate the actuator 220 during normal production and operating conditions.

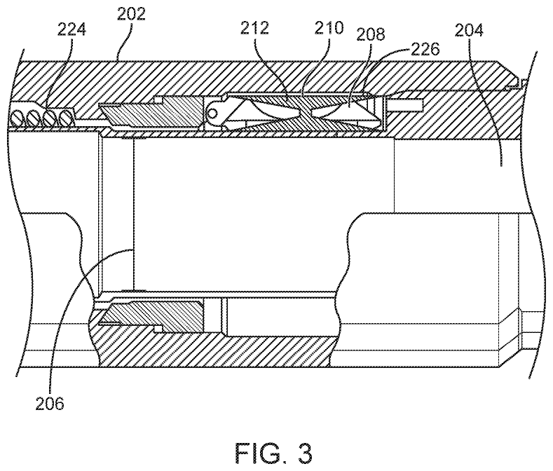

The elongate tubular body 202 can include a recess 226 within the inner bore 204 and configured to receive the flapper 208 in the bore open position as detailed in FIG. 3.

FIG. 3 illustrates a detailed view of a portion A-A of the flow meter apparatus shown in FIG. 2. The flow meter apparatus 200 is shown in a bore open position and having a flapper 208 disposed within a recess 226 formed in the inner bore 204. As can be appreciated in FIG. 3, the inner diameter 206 remains constant and unrestricted with the flapper 208 withdrawn into the recess 226. The recess 226 can be sized and shaped to conform to the dimensions of the flapper 208, thus forming a contoured fit. In other examples, the recess 226 can be a generic shape formed in the elongate tubular body 202, for example a rectangular inset.

FIG. 4 illustrates an example embodiment of a flow meter apparatus in a bore restricted position in accordance with the present disclosure. The flow meter apparatus 200 is in a bore restricted position having the flapper 208 exposed to the inner diameter 206 of the elongate tubular body 202. In the bore restricted position, the flapper 208 can perpendicularly intersect and impede the inner diameter 206, blocking all or at least a portion thereof and direct the permitted fluid flow within the inner bore 204 through the flow meter 210. The flapper 208 can restrict the inner diameter 206 to only allow fluid flow through the flow meter 210.

The flapper 208 can be actuated by a piston rod 238, which is one type of actuator 220, coupled with the control line 218. The control line 218 can receive an actuation signal causing actuation of the piston rod 238. As can be appreciated in FIG. 4, the actuation signal instructs the piston rod 238 to retract, thus allowing the biasing element 224 to expand and transition the flapper 208 to the bore restricted position. The flapper 208 in this arrangement is biased toward the bore restricted position. In other instances, the piston rod 238 can receive an actuation signal to expand and compress the biasing element 224, thereby transitioning the flapper to the bore restricted position. The flapper 208 in this arrangement is biased toward the bore open position.

When actuated, the flow meter 210 can generate a pressure differential within the inner bore 204 and allow a volumetric flow rate to be determined due to the pressure differential. A first pressure sensor 214 can be within the inner bore 204 and a second pressure sensor 216 can be disposed within the flow meter 210. The pressure differential between the first pressure sensor 214 and the second pressure sensor 216 can be used to determine a volumetric flow rate using Bernoulli's equation. Bernoulli's equation is reproduced below:

$${p}_{1} - {p}_{2} = \frac{ρ}{2} ( {v}_{2}^{2} - {v}_{1}^{2} )$$

Bernoulli's equation provides a relationship between a difference in two pressure measurements (p₁, p₂) with a difference in a first velocity (v₁) measured at the first pressure point (p₁) and a second velocity (v₂) measured at the second pressure point (p₂) relative to the density (ρ) of the fluid.

The first pressure sensor 214 can be disposed within the inner bore 204 prior to the flapper 208. The first pressure sensor 214 can be installed on a sidewall of the inner bore 204 and measure the pressure of the permitted fluid flow therethrough. The second pressure sensor 216 can be disposed within the flow meter 210 to measure the pressure increase within the permitted fluid flow caused by the obstruction of the inner diameter 206 by the flapper 208 in the bore restricted position. The first pressure sensor 214 and the second pressure sensor 216 can be any known sensor capable of measuring pressure of a fluid and can be wired or wirelessly communicatively coupled with the flow meter apparatus 200.

The flow meter 200 can further include a slidable flow tube 230 transitionable along with the flapper 208. The slidable flow tube 230 can maintain the inner diameter 206 when the flapper 208 is in the bore open position and maintain flapper 208 into the recess 226. In the bore restricted position, the slidable flow tube 230 displaces along the inner bore 204 and the flapper 208 can transition away from, and out of, the recess 226.

The slidable flow tube 230 can be a substantially cylindrical member displaceable along the inner bore 204 of the elongate tubular body 202. The slidable flow tube 230 can expose the recess 226 and a corresponding abutment recess 228. The flapper 208 can abut one edge of the abutment recess 228 opposite the pivotable coupling between the flapper 208 and the elongate tubular body 202. The abutment recess 228 can further provide clearance for the flapper 208 to pivot through the inner bore 204 to a substantially perpendicular position relative to the elongate tubular body 202.

The slidable flow tube 230 can maintain the inner diameter 206 when the flapper 208 is in the bore open position and prevent inducing turbulence into the flow stream by restricting fluid flow to the recess 226 and abutment recess 228. The slidable flow tube 230 can be transitionally coupled with the actuator 220 to displace as actuator 220 transitions the flapper 208 between the bore open position and the bore restricted position. In at least one instance, the slidable flow tube 230 displaces uphole relative to the flapper 208. In other instances, the slidable flow tube 230 can displace downhole relative to the flapper 208.

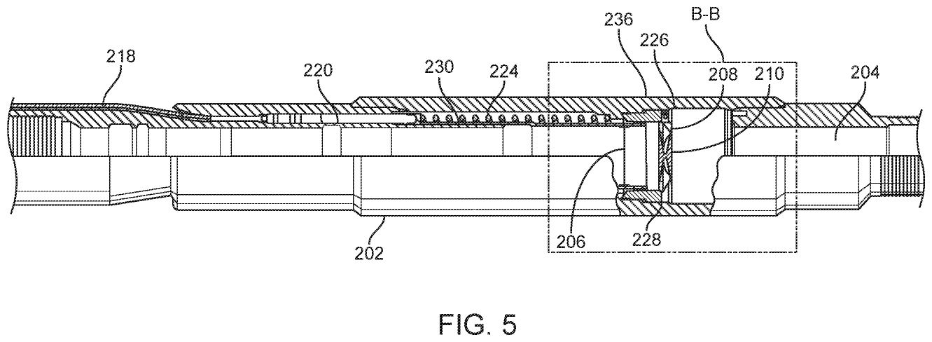

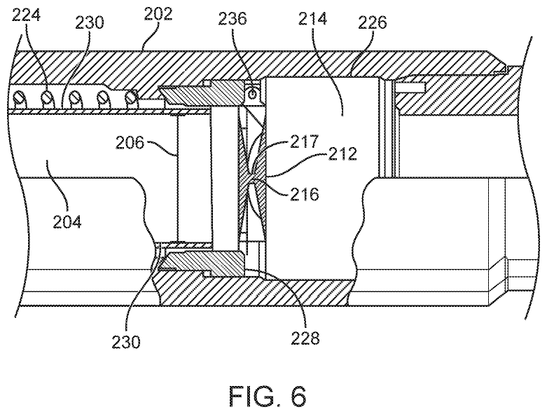

FIG. 5 illustrates the flow meter apparatus 200 with flapper 208 in a bore restricted position impeding fluid flow through the inner bore 204 and contracting or reducing the inner diameter 206, thus directing fluid flow through the flow meter 210.

The flapper 208 is substantially perpendicular to the direction of length 250 of the elongate tubular body 202 and the fluid flow permitted therethrough. While illustrated as perpendicular, it may be any position which restricts fluid flow through the inner bore 204. The actuator 220 is in an unactuated position and the biasing element 224 is uncompressed. In other instances, the actuator 220 can be in an actuated position and the biasing element 224 can be compressed in the bore restricted position.

FIG. 6 illustrates a close up more detailed view of the flow meter apparatus of FIG. 5 along portion B-B. As can be appreciated in FIG. 6, the flapper 208 is disposed within the inner bore 204 of the elongate tubular body 202 and exposes to a flow meter, in this case, a venturi 212 to the permitted fluid flow. The flapper 208 impedes fluid flow through the inner bore 204 creating a pressure differential though the venturi 212. A first pressure sensor 214 is provided within the inner bore 204 after the flapper 208 to measure a first pressure and a second pressure sensor 216 is provided in the throat 215 of the venturi 212 to measure a second pressure. In other instances, fluid flow can flow from the throat 215 into the second pressure sensor 216 can be mounted externally on flapper 208.

Due to the constriction of the fluid flow, the throat 215 can generate a higher pressure at the second pressure sensor 216. The pressure differential generated between the first pressure sensor 214 and the second pressure sensor 216 can determine a volumetric flow rate through the elongate tubular body 202, and thus through the flow meter apparatus 200. Applying Bernoulli's equation to the permitted fluid flow through the inner bore 204 and the flow meter 210 can allow a volumetric flow rate to be determined withoutshutting down production and requiring a crew to run tools downhole using wireline, slick line or some other conveyance. During normal production operations, the flapper 208 can be transitioned back to the bore open position.

FIG. 7 illustrates a flow meter apparatus according to the present disclosure employing a vena contracta rather than a venturi for measurement of flow. The flapper 208 can have an orifice plate 232 flow meter 210 disposed therein. The orifice plate 232 can create a measureable pressure differential within the elongate tubular body 202, thus allowing a volumetric flow rate to be determined. A first pressure sensor 214 can be disposed within the inner bore 204 and a second pressure sensor 216 can be disposed at a vena contracta 234 of the orifice plate 232. The vena contracta 234 can be the point where the diameter of a permitted fluid flow is a smallest. The flapper 208 may restrict the inner diameter 206 of the inner bore 204 thus forming the vena contracta 234 at the orifice plate 232.

As can be further appreciated in FIG. 7, the flow tube 230 has a magnetic coupling with the actuator 220 and biasing element 224. The flow tube 230 is magnetically coupled through the surface of the elongate tubular body 202 to allow transitioning of the flow tube 230 without a mechanical linkage extending through the elongate tubular body 202. When the actuator 220 actuates and compresses or releases the biasing element 224, a first magnetic element 240 moves and magnetically moves the (magnetic) flow tube 230, 242.

While the orifice plate 232 flow meter 210 is illustrated with a magnetic flow tube 242, it is within the scope of this disclosure to include the magnetic flow tube 242 with any flow meter and to implement the orifice plate 232 with any flow tube arrangement.

Numerous examples are provided herein to enhance understanding of the present disclosure. A specific set of statements are provided as follows.

Statement 1: An apparatus including an elongate tubular body having an inner bore, the inner bore permitting a fluid flow therethrough, a flapper coupled with the tubular body, and a flow meter coupled with the flapper, wherein the flapper is actuatable from a bore open position to a bore restricted position, and wherein in the bore open position the flapper is withdrawn from restricting the inner bore and in the bore restricted position the flow meter is exposed to the fluid flow.

Statement 2: The apparatus of Statement 1, wherein the flow meter is a venturi, the tubular body having a first pressure sensor in the inner bore and the flow meter having a second pressure sensor in a throat formed by the venturi.

Statement 3: The apparatus of Statement 1 or Statement 2, wherein the flow meter is an orifice plate, the tubular body having a first pressure sensor in the inner bore and the second pressure sensor at a vena contracta of the orifice plate.

Statement 4: The apparatus of any one of the preceding Statements 1-3, further comprising a control line coupled to an actuator, the control line configured to receive a signal to operate the actuator, and the actuator operably coupled with the flapper to transition the flapper from the bore restricted position to the bore open position.

Statement 5: The apparatus of any one of the preceding Statements 1-4, a biasing element coupled with the flapper and biasing the flapper toward the closed position

Statement 6: The apparatus of any one of the preceding Statements 1-5, wherein the actuator is one of an electric motor, linear actuator, or hydraulic actuator.

Statement 7: The apparatus of any one of the preceding Statements 1-6, wherein the control line is a tubing encapsulated conductor disposed within the tubular body.

Statement 8: The apparatus of any one of the preceding Statements 1-7, wherein the control line can transmit one or more signals from the flow meter.

Statement 9: The apparatus of any one of the preceding Statements 1-8, further comprising a second flapper disposed within the inner bore and independently transitionable between an open position and a closed position, in the closed position the second flapper preventing fluid flow through the inner bore.

Statement 10: The apparatus of any one of the preceding Statements 1-9, wherein the flow meter is disposed within the flapper.

Statement 11: The apparatus of any one of the preceding Statements 1-10, wherein when the flapper is in the bore open position the flapper is recessed within the inner bore maintaining an inner diameter of the inner bore and when the flapper is in the bore restricted position the flapper blocks at least a portion of the inner bore, thus directing fluid flow through the flow meter.

Statement 12: A production string including a plurality of elongate tubular bodies having an inner bore, the inner bore permitting a fluid flow therethrough, at least one of the plurality of elongate tubular bodies further including a flapper coupled with the tubular body, and a flow meter coupled with the flapper, wherein the flapper is actuatable from a bore open position to a bore restricted position, wherein in the bore open position the flapper is withdrawn from restricting the inner bore and in the bore restricted position the flow meter is exposed to the fluid flow.

Statement 13: The production string of Statements 12, wherein the flow meter is a venturi, the tubular body having a first pressure sensor in the inner bore and the flow meter having a second pressure sensor in a throat formed by the venturi.

Statement 14: The production string of Statement 12 or 13, wherein the flow meter is an orifice plate, the tubular body having a first pressure sensor in the inner bore and the second pressure sensor at a vena contracta of the orifice plate.

Statement 15: The production string of any one of the preceding Statements 12-14, further comprising a control line coupled to an actuator, the control line configured to receive a signal to operate the actuator, and the actuator operably coupled with the flapper to transition the flapper from the bore restricted position to the bore open position

Statement 16: The apparatus of Statement 15, wherein the actuator is one of an electric motor, linear actuator, or hydraulic actuator.

Statement 17: The apparatus of Statement 15 or 16, wherein the control line is a tubing encapsulated conductor disposed within the tubular body.

Statement 18: A system including an elongate tubular body having an inner bore, the inner bore permitting a fluid flow therethrough, a flapper coupled with the tubular body, and a flow meter coupled with the flapper, wherein the flapper is actuatable from a bore open position to a bore restricted position, and wherein in the bore open position the flapper is withdrawn from restricting the inner bore and in the bore restricted position the fluid flow in the inner bore is restricted to flow through the flow meter.

Statement 19: wherein a venturi is formed in the flapper, and wherein in the bore restricted position the inner bore is restricted to fluid flow through the venturi.

Statement 20: The system of Statement 19, wherein the tubular body has a first pressure sensor in the inner bore and the venturi has a second pressure sensor in a throat of the venturi.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. An apparatus comprising:
an elongate tubular body having an inner bore, the inner bore permitting a fluid flow therethrough;
a flapper coupled with the tubular body; and
a flow meter coupled with the flapper;
wherein the flapper is actuatable from a bore open position to a bore restricted position, and
wherein in the bore open position the flapper is withdrawn from restricting the inner bore and in the bore restricted position the flow meter is exposed to the fluid flow.

2. The apparatus of claim 1, wherein the flow meter is a venturi, the tubular body having a first pressure sensor in the inner bore and the flow meter having a second pressure sensor in a throat formed by the venturi.

3. The apparatus of claim 1, wherein the flow meter is an orifice plate, the tubular body having a first pressure sensor in the inner bore and the second pressure sensor at a vena contracta of the orifice plate.

4. The apparatus of claim 1, further comprising a control line coupled to an actuator, the control line configured to receive a signal to operate the actuator, and the actuator operably coupled with the flapper to transition the flapper from the bore restricted position to the bore open position.

5. The apparatus of claim 4, a biasing element coupled with the flapper and biasing the flapper toward the closed position.

6. The apparatus of claim 4, wherein the actuator is one of an electric motor, linear actuator, or hydraulic actuator.

7. The apparatus of claim 4, wherein the control line is a tubing encapsulated conductor disposed within the tubular body.

8. The apparatus of claim 4, wherein the control line can transmit one or more signals from the flow meter.

9. The apparatus of claim 1, further comprising a second flapper disposed within the inner bore and independently transitionable between an open position and a closed position, in the closed position the second flapper preventing fluid flow through the inner bore.

10. The apparatus of claim 1, wherein the flow meter is disposed within the flapper.

11. The apparatus of claim 1, wherein when the flapper is in the bore open position the flapper is recessed within the inner bore maintaining an inner diameter of the inner bore and when the flapper is in the bore restricted position the flapper blocks at least a portion of the inner bore, thus directing fluid flow through the flow meter.

12. A production string comprising:
a plurality of elongate tubular bodies having an inner bore, the inner bore permitting a fluid flow therethrough;
at least one of the plurality of elongate tubular bodies further comprising:
a flapper coupled with the tubular body; and
a flow meter coupled with the flapper;
wherein the flapper is actuatable from a bore open position to a bore restricted position,
wherein in the bore open position the flapper is withdrawn from restricting the inner bore and in the bore restricted position the flow meter is exposed to the fluid flow.

13. The production string of claim 12, wherein the flow meter is a venturi, the tubular body having a first pressure sensor in the inner bore and the flow meter having a second pressure sensor in a throat formed by the venturi.

14. The production string of claim 12, wherein the flow meter is an orifice plate, the tubular body having a first pressure sensor in the inner bore and the second pressure sensor at a vena contracta of the orifice plate.

15. The production string of claim 12, further comprising a control line coupled to an actuator, the control line configured to receive a signal to operate the actuator, and the actuator operably coupled with the flapper to transition the flapper from the bore restricted position to the bore open position.

16. The production string of claim 15, wherein the actuator is one of an electric motor, linear actuator, or hydraulic actuator.

17. The production string of claim 15, wherein the control line is a tubing encapsulated conductor disposed within the tubular body.

18. A system comprising:
an elongate tubular body disposed in a wellbore and having an inner bore, the inner bore permitting a fluid flow therethrough;
a flapper coupled with the tubular body; and
a flow meter coupled with the flapper;
wherein the flapper is actuatable from a bore open position to a bore restricted position, and
wherein in the bore open position the flapper is withdrawn from restricting the inner bore and in the bore restricted position the fluid flow in the inner bore is restricted to flow through the flow meter.

19. The system of claim 19, wherein a venturi is formed in the flapper, and wherein in the bore restricted position the inner bore is restricted to fluid flow through the venturi.

20. The system of claim 19, wherein the tubular body has a first pressure sensor in the inner bore and the venturi has a second pressure sensor in a throat of the venturi.
